(19) United States
(12) Patent Application Publication
(10) Pub. No.: US 2005/0165810 A1
(43) Pub. Date: Jul. 28, 2005

(54) Generating and providing device management data via network

(76) Inventor: Akira Yokoyama, Kanagawa-ken (JP)

Correspondence Address: COOPER & DUNHAM, LLP, 1185 AVENUE OF THE AMERICAS, NEW YORK, NY, 10036, US

(21) Appl. No.: 11/042,789

(22) Filed: Jan. 24, 2005

(30) Foreign Application Priority Data
Jan. 26, 2004 (JP) 2004-016621

(51) Int. Cl. G06F 7/00

(52) U.S. Cl. 707/100

(57) ABSTRACT

An apparatus, system, method, computer program and product are provided for generating device management data in a predetermined XML-based format to a client, and providing the device management data in a format readable to a client, using web services technology.

### BACKGROUND OF THE INVENTION

1. Field of the Invention

The present invention relates to generating, converting, and providing device management data using web services technology. More specifically, the present invention relates to generating and converting device management data, written in an XML (extensible markup language), and to providing the device management data via web services technology.

2. Discussion of the Background

Recently, a large number of companies are implementing web services to integrate different software applications within the enterprise and/or to extend their reach to customers or business partners.

For example, a web service may be used to manage various devices connected to a network. More specifically, the web service may generate device management data, including information regarding the respective devices, using XML. The device management data is then passed between the devices using web services technology.

Web service technology, which is vendor-independent, includes a number of different protocols and standards, not withstanding of standardization efforts driven by industry associations, such as the World Wide Web Consortium (W3C), for example. Further, some of the protocols and standards are constantly replaced by new ones, making the web service technology more complicated.

In addition to the above-described problem, there is still a need for converting between HTML (hypertext markup language) and XML, as a large number of HTML-based documents continue to exist on the Web.

### SUMMARY OF THE INVENTION

Exemplary embodiments of an apparatus, system, method, computer program and product, are described in this disclosure for generating and providing device management data in a predetermined XML-based format to a client, using web services technology.

In addition, exemplary embodiments of an apparatus, system, method, computer program and product, are also described for generating device management data in a predetermined XML-based format, converting the device management data from the predetermined XML-based format to a client format readable to a client, and providing the converted device management data to the client, using web services technology.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a block diagram illustrating a functional structure of a network apparatus, according to a preferred embodiment of the present disclosure;

FIG. 2 is a block diagram illustrating a hardware structure of a network apparatus according to another preferred embodiment;

FIG. 3 is a block diagram illustrating a storage device shown in FIG. 2;

FIG. 4 is a block diagram illustrating a hardware structure of a network apparatus according to another preferred embodiment;

FIG. 5 is a block diagram illustrating a software structure of the network apparatus shown in any one of FIGS. 2 and 4;

FIG. 6 is a block diagram illustrating a portion of the software structure of FIG. 5;

FIG. 7 is a flowchart illustrating exemplary operations for generating device management data according to a preferred embodiment;

FIG. 8 is a table illustrating contents of information stored as device management data in the storage device of FIG. 3;

FIG. 9 is a flowchart illustrating exemplary operations for generating device management data according to another preferred embodiment; and

FIG. 10 is a flowchart illustrating exemplary operations for generating device management data according to another preferred embodiment.

### DETAILED DESCRIPTION OF PREFERRED EMBODIMENTS

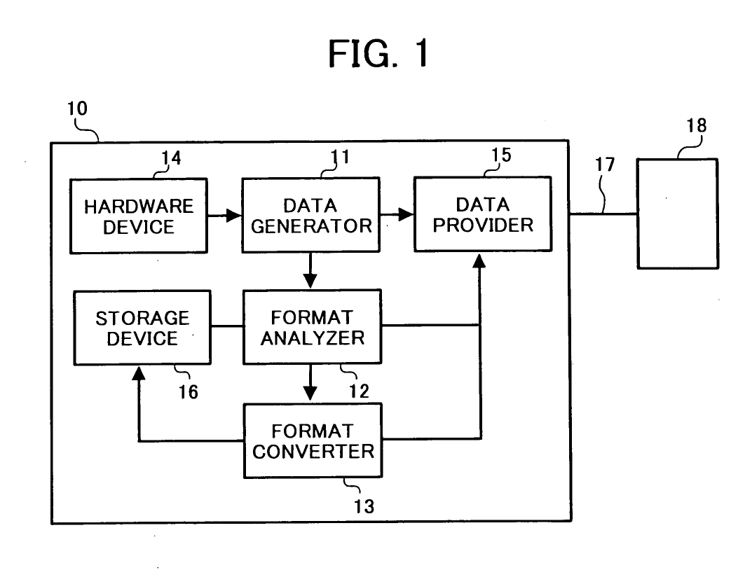

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIG. 1, a description is made of a network apparatus 10 according to a preferred embodiment.

The network apparatus 10 of FIG. 1 includes a data generator 11, a format analyzer 12, a format converter 13, a data provider 15, a hardware device 14, and a storage device 16. The network apparatus 10 includes any kind of apparatus capable of providing device management data to a client 18 through a network 17, using web services technology.

The data generator 11 generates device management data of the hardware device 14 in a predetermined XML-based format. The device management data includes various kinds of information regarding the hardware device 14, including its status and operating states. The contents of information stored as the device management data corresponds to a specific function provided by the hardware device 14. For example, if the hardware device 14 provides a printing function, the device management data includes size or type of paper, availability of paper, a list of printed documents, etc.

The data generator 11 may generate device management data at a predetermined timing. The predetermined timing includes, for example, a timing defined by the network apparatus 10 or the client 18, timing when the network apparatus 10 receives a request from the client 18, or a timing when information regarding the hardware device 14 is updated. The data generator 11 may store the device management data in the hardware device 16 or any other storage device connected to the network apparatus 10.

The format analyzer 12 specifies a format requested by the client 18, or a format readable to the client 18. For example, the format analyzer 12 may ask the client 18 for a specific client format, or the format analyzer 12 may extract information regarding a specific client format from a request sent from the client 18.

Once the client format is specified, the format analyzer 12 determines if the client format matches the predetermined XML-based format. If they match, the format analyzer 12 sends the device management data to the data provider 15. If they do not match, the format analyzer 12 further determines if the client format is supported by the network apparatus 10.

To determine if the client format is supported, the format analyzer 12 may store a format list, which lists a plurality of formats supported by the network apparatus 10, in the storage device 16. If the specified client format is listed in the format list, the format analyzer 12 instructs the format converter 13 to convert the device management data from the predetermined XML-based format to the client format. If the specified client format is not listed in the format list, the format analyzer 12 may send an error message to the client 18.

Alternatively, the format analyzer 12 may instruct the format converter 13 to convert the predetermined XML-based format to the client format, without making such determination.

Further, as in the above-described case of the data generator 11, the format analyzer 12 may specify a client format at any timing.

The format converter 13, after receiving the instruction from the format analyzer 12, converts the device management data from the predetermined XML-based format to the client format. For example, the format converter 13 may store a plurality of conversion files corresponding, respectively, to the formats listed in the format list, in the storage device 16. The format converter 13 obtains a particular conversion file corresponding to the specified client format from the storage device 16. Using the conversion file, the format converter 13 converts the device management data to the client format. After conversion, the format converter 13 provides the converted device management data to the data provider 15.

The format converter 13 may not be able to find the particular conversion file corresponding to the client format, when the format analyzer 12 has not determined if the client format is supported, or when the format list is not provided. If the particular conversion file is not found, the format converter 13 may send an error message to the client 18.

The data provider 15 provides the device management data to the client 18 through the network 17.

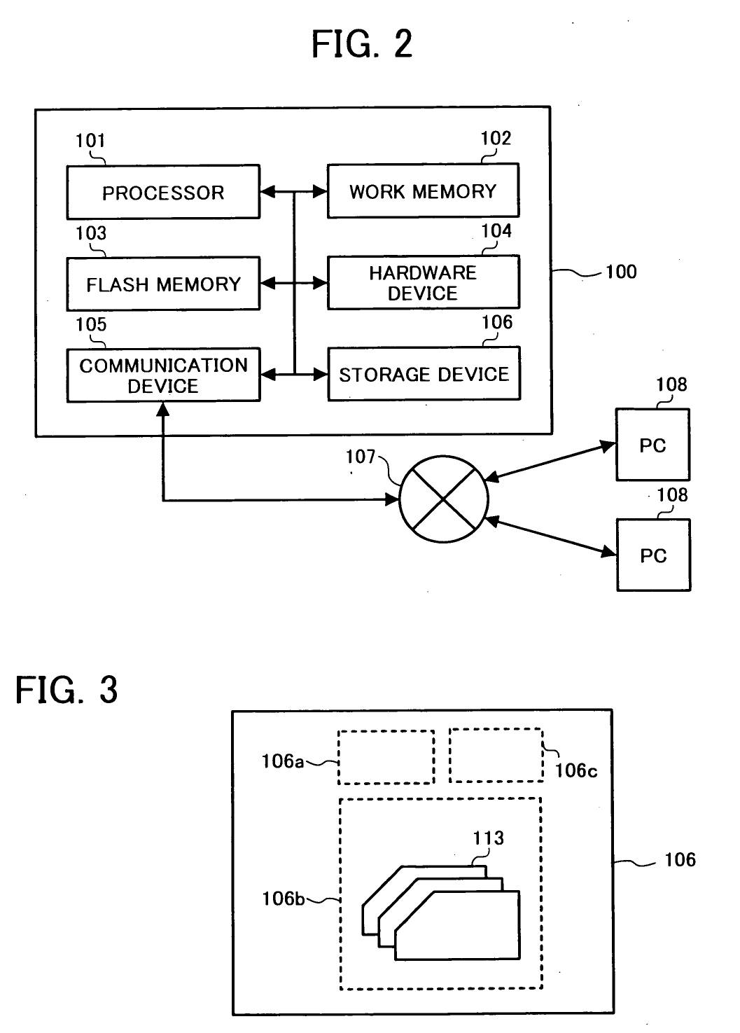

The network apparatus 10 may be implemented in various ways or systems, for example, as office equipment, communication devices, image processing devices, and home appliances, depending on the specific function provided by the hardware device 14. Referring now to FIGS. 2 to 10, a network apparatus 100 having a copier function, a printer function, and a fax function, is explained as one exemplary implementation of the network apparatus 10.

As shown in FIG. 2, the network apparatus 100 includes a processor 101, a work memory 102, a flash memory 103, a hardware device 104, a communication device 105, and a storage device 106.

The processor 101 includes any kind of processor, capable of controlling an entire operation of the network apparatus 100. The processor 101 performs at least one of the copier function, the printer function and the fax function, in combination with the hardware device 104.

The work memory 102 includes any kind of volatile memory, such as a RAM (random access memory). The flash memory 103 includes any kind of nonvolatile memory, such as a ROM (read only memory).

The hardware device 104 includes a set of specific hardware components related to the copier function, the printer function, and the fax function, respectively.

The communication device 105 includes any kind of interface based on the web services technology, including SOAP (simple object access protocol), for example. The network 107 preferably includes the Internet.

The client 108 of FIG. 2 includes two personal computers, however, the client 108 may include any number of personal computers or any other kind of devices operating as a personal computer, such as PDA (personal digital assistant) devices, for example. Further, the client 108 may include or may be connected to one or more peripheral devices. For example, the client 108 may send a command to the network apparatus 100 using an input device, or display information received from the network apparatus 100 using a display device.

Further, to request the network apparatus 100 for device management data or to display device management data, the client 108 may include any one of software programs, including a web browser capable of reading a HTML document and an RSS reader capable of reading an RSS document, for example.

The storage device 106 includes any kind of storage device, such as a hard disk drive, capable of storing a large amount of data. As illustrated in FIG. 3, the storage device 106 may store device management data in a first data section 106a, a plurality of conversion files 113 in a second data section 106b, and a format list in a third data section 106c.

Further, the storage device 106 includes computer-readable programs, including various application programs and a device management program. When the network apparatus 100 is activated, the network apparatus 100 loads the device management program and one or more related application programs onto the flash memory 103, and causes the processor 101 and the hardware device 104 to operate, for example, in the manner of the network apparatus described referring to FIG. 1.

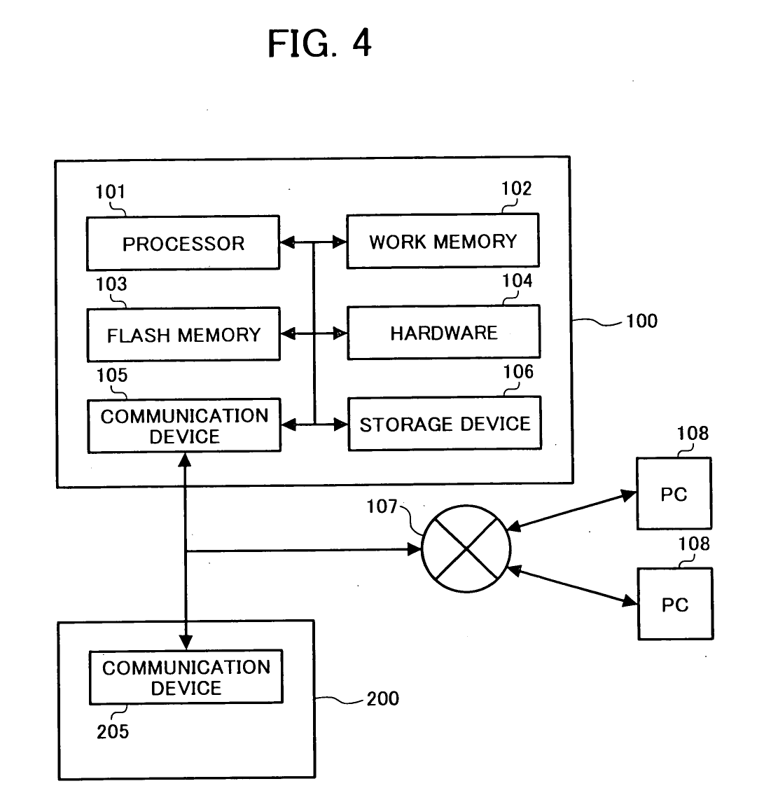

FIG. 4 illustrates another system incorporating the network apparatus 100. The system of FIG. 4 is substantially similar to the one shown in FIG. 2, except for the addition of a device 200, which is connected to the network apparatus 100 through the network 107.

The device 200 may include any kind of peripheral device connectable to the network 107 via a communication device 205, which is substantially similar to the communication device 105. In one example, the device 200 may be implemented as a document server, capable of storing document data handled by the client 108. In another example, the device 20 may be implemented as a mail server, capable of handling email data received from or sent to the client 108.

In operation, the network apparatus 100 generates device management data, which includes information regarding the device 200 in addition to information regarding the network apparatus 100, i.e. hardware device 104. In this way, the client 108 can monitor all devices on the network 107, while device diversity is transparent to the client.

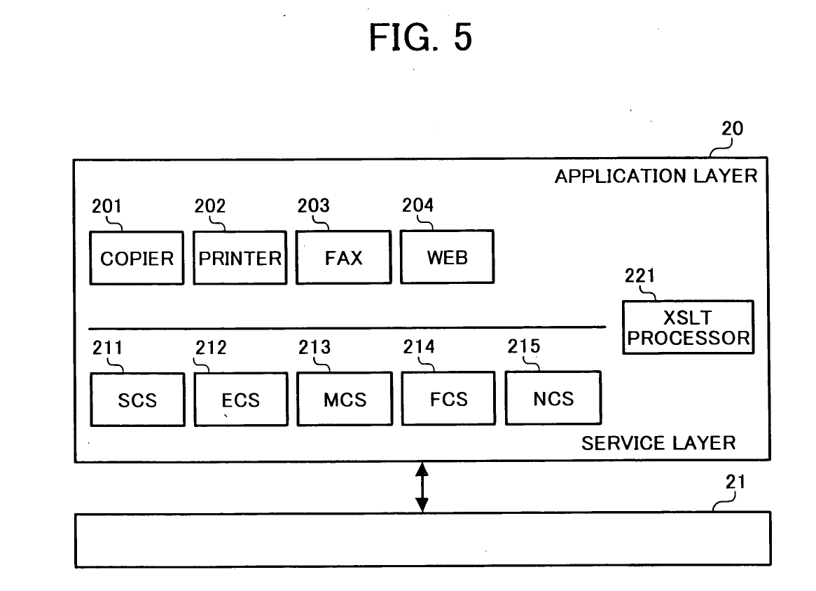

Referring now to FIG. 5, an exemplary architecture for a network apparatus is explained.

The architecture of FIG. 5 mainly includes a software architecture 20 having an application layer and a service layer, a hardware architecture 21, and an XSLT (extensible stylesheet language transformations) processor 221.

The application layer of the software architecture 20 includes various application programs corresponding to the functions provided by the hardware device 104; and a device management program such as having the features describes herein, amongst others. More specifically, the application layer includes a copier application 201 providing the copier function, a printer application 202 providing the printer function, a fax application 203 providing the fax function, and a web application 204 functioning as the device management program.

The service layer of the software architecture 20 includes various services, which may be commonly used by the application programs. In this exemplary case, the service layer includes a system control service (SCS) 211, an engine control service (ECS) 212, a memory control service (MCS) 213, a fax control service (FCS) 214, and a network control service (NCS) 215. The SCS 211 controls an entire operation of the network apparatus 100. The ECS 212 controls various kinds of engine, including an input engine such as a scanner engine, or an output engine such as a plotter engine, for example. The MCS 213 controls an entire operation related to the storage device 106. The FCS 214 controls an entire operation related to the fax function. The NCS 215 controls input or output of data to or from the network apparatus 100.

The service layer may further include a delivery control service (DCS), a user information control service (UCS), or a certificate control service (CCS), for example, depending on a specific operation provided by the network apparatus 100.

The hardware architecture 21 includes any kind of hardware component of the hardware device 14. For example, the hardware architecture 21 may include an input engine such as the scanner engine, or an output engine such as the plotter engine.

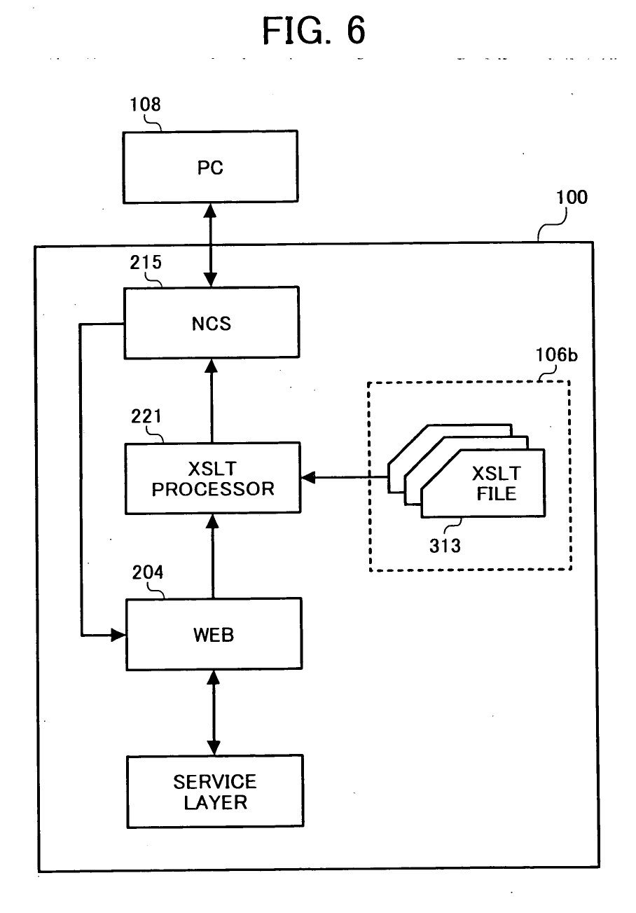

The XSLT processor 221 can function as the format converter 13 of FIG. 1, capable of converting device management data from the predetermined XML-based format to a client format. The XSLT processor 221 includes any kind of XSLT processors known in the art. The storage device 106 stores a plurality of XSLT files 313 in the second data section 106b, as illustrated in FIG. 6.

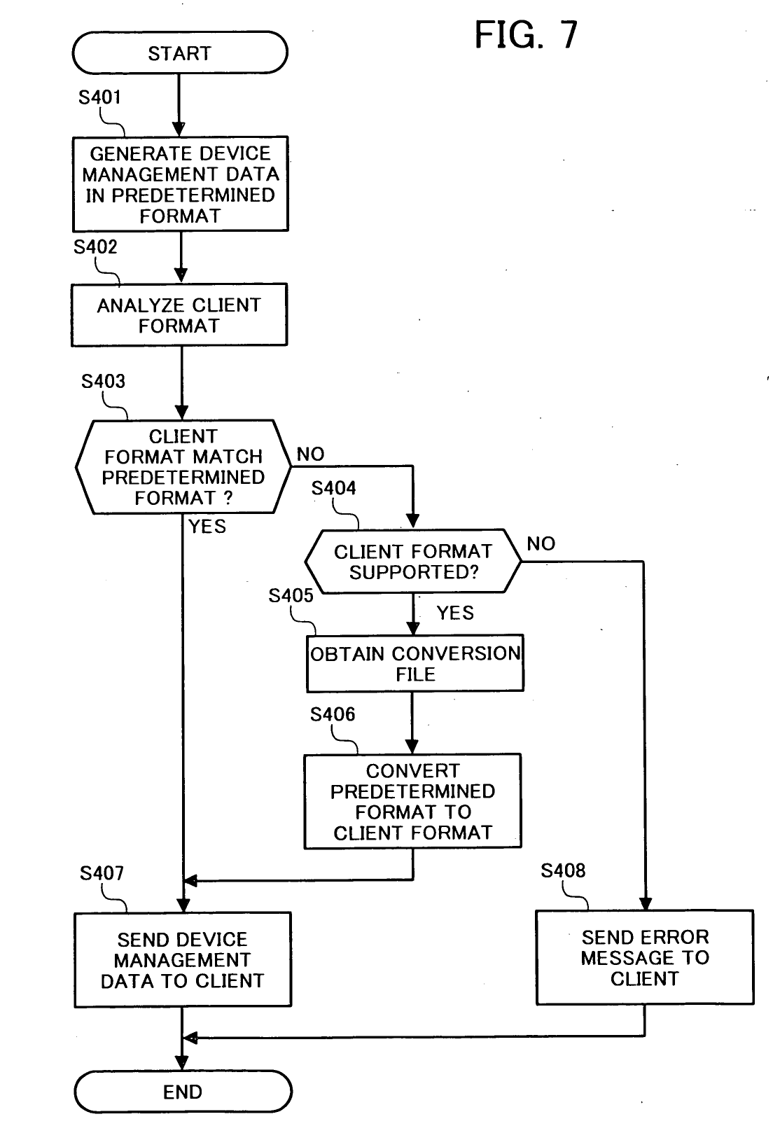

Referring to FIGS. 6 and 7, an exemplary operation of generating and providing device management data, performed by the network apparatus 100 of FIG. 2 having the architecture of FIG. 5 is explained. In this exemplary case, the network apparatus 100 performs the steps shown in FIG. 7 after receiving a request command from the client 108. However, the steps of FIG. 7 may be performed at any other timing, as described referring to FIG. 1.

Step S401 obtains information regarding the hardware architecture 21 from at least one of the services 211 to 214, according to the request command of the client 108. In one example, if the client 108 requests device management data related to the printer function, the web application 204 obtains information regarding the hardware component related to the printer function. In another example, if the client 108 requests device management data related to the copier, printer, and fax functions, the web application 204 obtains information regarding the hardware components related to the copier, printer, and fax functions.

Step S401 then generates device management data in a predetermined XML-based format, based on the obtained information. The XML-based format may be selected from XML family of technologies, including various XML applications such as RDF (resource description framework) and XForms, depending on a specific use of the network apparatus 100. For example, if the device management data is to be updated periodically, RSS (RDF site summary) may be preferably used as the predetermined XML-based format. Other XML-based formats can of course also be used.

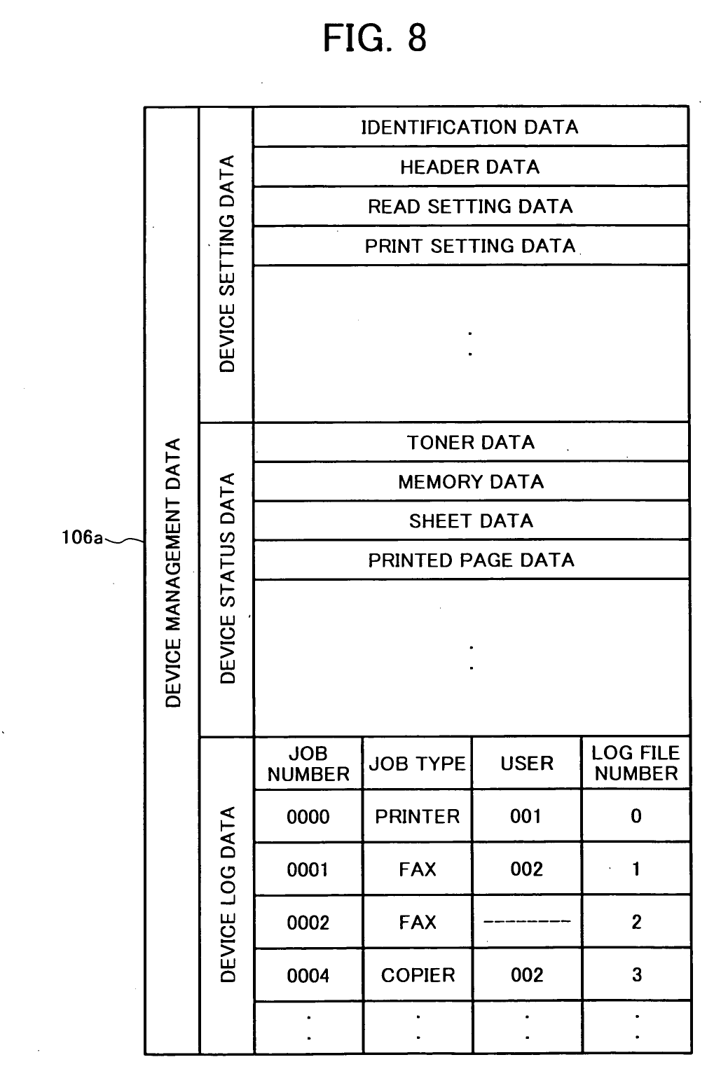

The device management data includes various kinds of information regarding the hardware architecture 21, as illustrated in FIG. 8, for example. The device management data of FIG. 8 can include device setting data, device status data, and device log data.

The device setting data describes initial setting of the hardware architecture 21, i.e. the respective hardware components of the hardware device 104. For example, the device setting data may include identification data such as a fax number, a network IP address, or a DNS server assigned to the network apparatus 100, header data to be added to data being sent, read setting data indicating reading conditions such as a reading resolution, print setting data indicating printing conditions such as a printing resolution, etc.

The device status data describes current status of the network apparatus 100. For example, the device status data may include toner data indicating toner supply, memory data indicating an available memory size, sheet data indicating paper supply, printed page data indicating an amount of printed pages, etc.

The device log data describes activities or jobs performed by the network apparatus 100. For example, the device log data may include job number data indicating an identification number assigned to each job being performed, job type data indicating a type of the job, i.e., a function of the network apparatus 100 performing the job, user data indicating a user who has requested to perform the job, log file number data indicating an identification number assigned to a log file describing the job, etc.

For example, as illustrated in FIG. 8, if a user 001, through the client 108, requests the network apparatus 100 to perform a job of printing one sheet of paper, this job may be assigned with a job number “0000”. As the job type, “PRINTER” is selected. Further, a log file having a log file number “0” may be created, including a number of sheets being printed, a type or size of the sheet being used, etc.

After receiving the device management data, Step S402 specifies a client format, by referring to the request command, which is preferably written based on HTTP or any other Internet-based protocol.

In one example, the request command may be written in the POST method, as described as
“http://xxx.yyy.zzz.www/html/machineState.cgi”, or http://xxx.yyy.zzz.www/rss1.0/machineState.cgi”, for example.

Alternatively, the request command may :be written in the GET method, as described as
“http://xxx.yyy.zzz.www/machineState.cgi?type=html” or “http://xxx.yyy.zzz.www/machineState.cgi?type=rss&ver=1.0”, for example.

In any one of the above-described methods, the request command may be complied with the SOAP encoding rules.

Step S403 determines whether the client format matches the predetermined XML-based format. If yes, the process moves to Step S407 to send the device management data to the client 18 through the NCS 215. If no, the process moves to Step S404.

Step S404 determines whether the client format is supported by the network apparatus 100, by referring to the format list stored in the storage device 106, for example. As described above referring to FIG. 1, the format list may indicate a plurality of formats supported by the network apparatus 100. More specifically, the format list includes information regarding the supported formats, such as their names or versions. If the client format is supported, that is, “yes” in Step S404, the process moves to Step S405, and otherwise, the process moves to Step S408.

Step S408 sends an error message to the client 108, indicating that the client format is not supported by the network apparatus 100. The error message may include a status code displaying “400 Bad Request” or “404 Not Found”, for example.

Step S405 obtains the storage device 106 for an XSLT file corresponding to the client format.

Step S406 converts the device management data using the obtained XSLT file, and the process moves to Step S407 to send the converted device management data to the client 108 through the NCS 215.

For example, if the predetermined XML-based format includes RSS2.0, and HTML is requested as the client format, the XSLT processor 221 obtains an XSLT file corresponding to the HTML, and converts the device management data from RSS2.0 format to HTML format using the obtained XSLT file.

In another example, if the predetermined XML-based format includes RSS1.0, and RSS2.0 is requested as the client format, the XSLT processor 221 obtains an XSLT file corresponding to the RSS2.0, and converts the device management data from RSS1.0 to RSS2.0 using the obtained XSLT file.

Upon receiving the device management data, the client 108 displays the device management data, using an appropriate software program capable of reading the client format. For example, the client 108 uses a web browser to read the device management data written in HTML. In another example, the client 108 uses an RSS reader to read the device management data written in RSS.

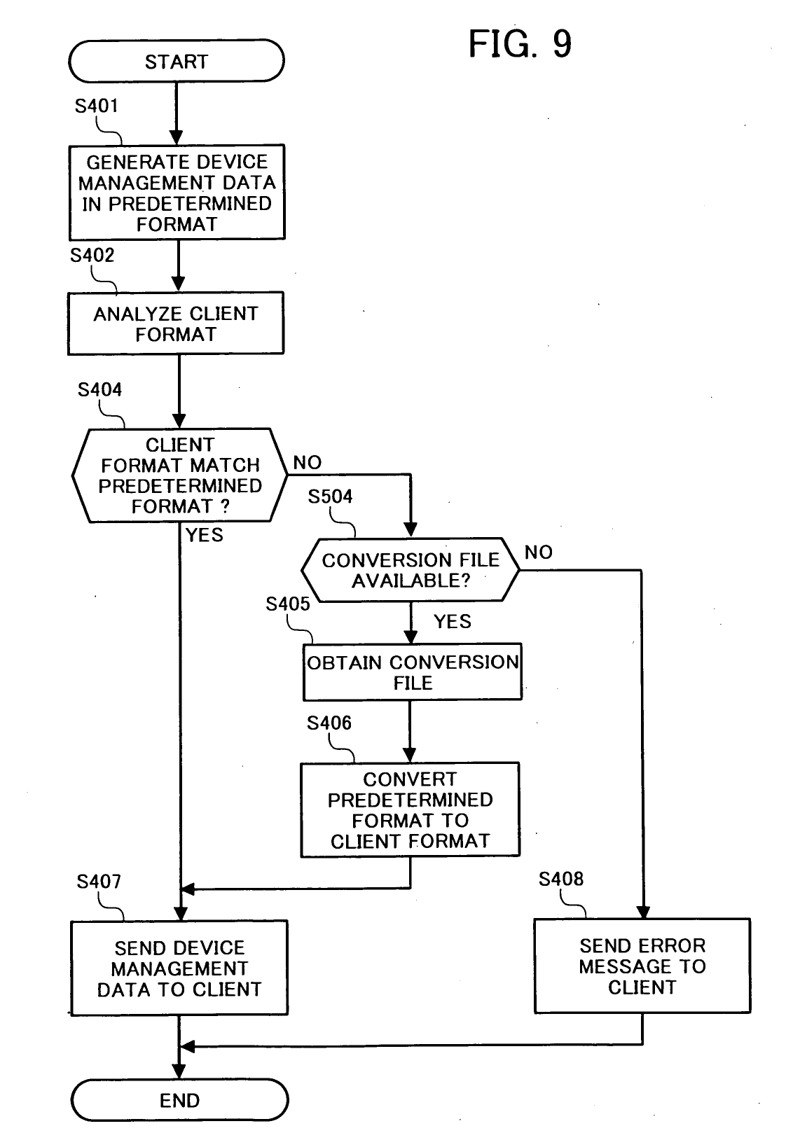

FIG. 9 illustrates an exemplary operation of generating and providing device management data, performed by the network apparatus 100 of FIG. 2 having the software architecture of FIG. 5, according to another preferred embodiment of the present invention. The operation of FIG. 9 is substantially similar to the operation of FIG. 7, except that Step S404 is replaced with Step S504.

Step S504 determines whether the client format is supported by the network apparatus 100, by referring to the plurality of conversion files stored in the storage device 106, for example. Accordingly, the format list may not be stored in the storage device 106.

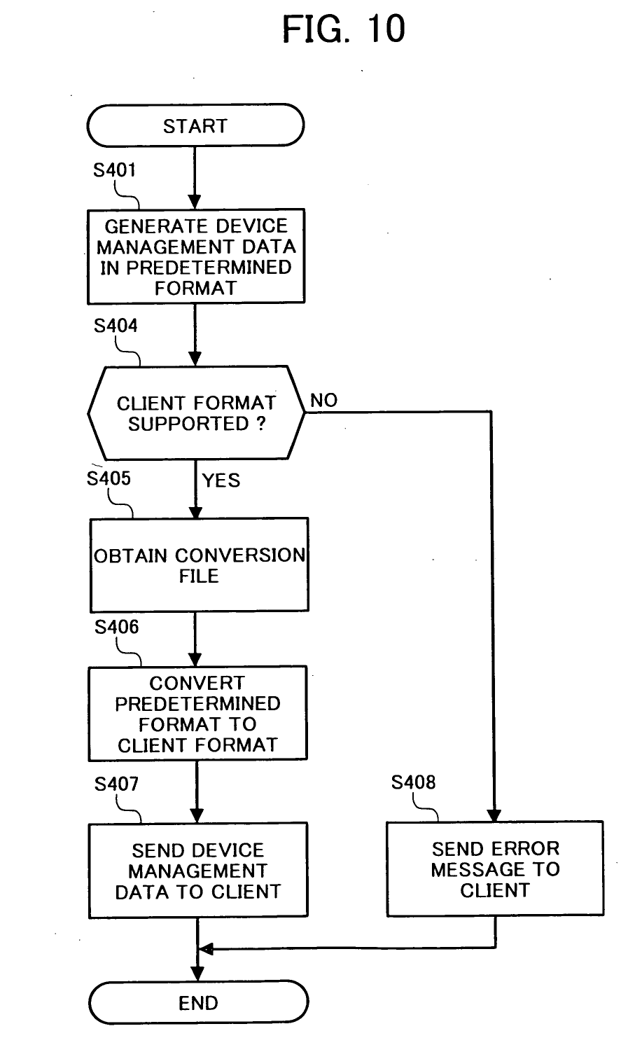

FIG. 10 illustrates an exemplary operation of generating and providing device management data, performed by the network apparatus 100 of FIG. 2 having the software architecture of FIG. 5, according to another preferred embodiment. The operation of FIG. 10 is substantially similar to the operation of FIG. 7, except for the deletion of Steps S402 and S403.

In this exemplary operation of FIG. 10, the network apparatus 100 performs format conversion, even when the client format matches the predetermined XML-based format.

Alternatively, Step S404 of FIG. 10 may be replaced with Step S504 of FIG. 9.

The flowcharts of FIGS. 7, 9, and 10 describe exemplary operations performed by the network apparatus 100 of FIG. 2. However, the exemplary operations of these flowcharts may also be performed by the network apparatus 100 of FIG. 4. If the network apparatus 100 of FIG. 4 is used, Step S401 obtains information regarding the device 200, in addition to the information regarding the network apparatus 100.

Numerous additional modifications and variations are possible in light of the above teachings. For example, features of different illustrative embodiments may be combined with each other and/or substituted for each other within the scope of this disclosure and appended claims.

It is therefore to be understood that within the scope of the appended claims, the disclosure of this patent specification may be practiced otherwise than as specifically described herein.

For example, instead of sending a request command using the client 108, a user may directly request the network apparatus 100 for device management data, using an operational panel or key provided therewith.

Further, the format list or the plurality of conversion files may be stored in any storage device, other than the storage device 106, as long as they are downloadable by the network apparatus 100 for the operation. Similarly, the format list or the plurality of conversion files may be stored in any kind of storage medium, including floppy disks, optical discs, flash memory, magnetic or optical cards, etc.

Furthermore, the present invention may be implemented using one or more microprocessors and/or signal processors programmed according to the teachings of the present disclosure, as mentioned above. Alternatively, the present invention may be implemented by ASIC (Application Specific Integrated Circuit), prepared by an appropriate network of component circuits or by a combination thereof according to the present disclosure.

This patent specification is based on Japanese patent application No. JPAP2004-016621, filed on Jan. 26, 2004, in the Japanese Patent Office, the entire contents of which are incorporated by reference herein.

1. A network apparatus connectable to a client through a network, said network apparatus comprising:
a hardware device configured to provide a device-specific function to the network apparatus;
a data generator configured to generate device management data of the hardware device in a predetermined XML-based format;
a format analyzer configured to specify a client format readable to the client, and to compare the client format with the predetermined XML-based format to generate a comparison result;
a format converter configured to convert the device management data in the predetermined XML-based format to the client format based on the comparison result; and
a data provider configured to provide the device management data to the client.

2. The network apparatus of claim 1, wherein the predetermined XML-based format includes RDF.

3. The network apparatus of claim 1, wherein the client format is based on HTML.

4. The network apparatus of claim 1, wherein the client format is included in a request command received from the client.

5. The network apparatus of claim 1, further comprising:
a storage device configured to store a format list, including information whether the client format is supported by the network apparatus.

6. The network apparatus of claim 5, wherein the format analyzer is configured to further determine whether the client format is supported by the network apparatus by referring to the format list.

7. The network apparatus of claim 6, wherein the format analyzer is configured to further send an error message when the determination indicates that the client format is not supported.

8. The network apparatus of claim 1, further comprising:
a storage device configured to store a plurality of conversion files, with each conversion file corresponding to a specific XML-based format.

9. The network apparatus of claim 8, wherein the format converter is configured to obtain a conversion file corresponding to the client format, and to perform the conversion using the obtained conversion file.

10. The network apparatus of claim 8, wherein the format converter is configured to send an error message to the client, when a conversion file corresponding to the client format is not obtained.

11. The network apparatus of claim 9, wherein the conversion file includes an XSLT file.

12. A network apparatus connectable to a shared device and a client through a network, said network apparatus comprising:
a hardware device configured to provide a device-specific function to the network apparatus;
a data generator configured to generate device management data including information regarding the hardware device and the shared device in a predetermined XML-based format;
a format analyzer configured to specify a client format readable to the client, and to compare the client format with the predetermined XML-based format to generate a comparison result;
a format converter configured to convert the device management data in the predetermined XML-based format to the client format based on the comparison result; and
a data provider configured to provide the device management data to the client.

13. A network apparatus connectable to a client through a network, said network apparatus comprising:
a processor;
a storage device configured to store a plurality of instructions which, when executed by the processor, cause the processor to perform operations including:
generating device management data in a predetermined XML-based format;
specifying a client format readable to the client; and
providing the device management data in the client format.

14. The network apparatus of claim 13, wherein the operations further include:
converting the device management data in the predetermined XML-based format to the client format.

15. A data providing method comprising:
generating device management data in a predetermined XML-based format;
specifying a client format readable to a client; and
providing the device management data in the client format to the client.

16. The method of claim 15, further comprising:
converting,the device management data in the predetermined XML-based format to the client format.

17. A program storage device readable by a machine, tangibly embodying a program of instructions executable by the machine to perform the method claimed in claim 15.

18. A computer data signal transmitted in one or more segments in a transmission medium which embodies instructions executable by a computer to perform the method claimed in claim 15.

19. A data obtaining method comprising:
sending a request command for device management data to a network apparatus;
specifying a client format; and
displaying the device management data in the client format.
